(19) United States
(12) Patent Application Publication
(10) Pub. No.: US 2023/0299627 A1
(43) Pub. Date: Sep. 21, 2023

(54) ROTOR

(71) Applicant: TOYOTA JIDOSHA KABUSHIKI KAISHA, Toyota-shi (JP)

(72) Inventor: Masafumi SUZUKI, Miyoshi-shi (JP)

(73) Assignee: TOYOTA JIDOSHA KABUSHIKI KAISHA, Toyota-shi (JP)

(21) Appl. No.: 18/105,552

(22) Filed: Feb. 3, 2023

(30) Foreign Application Priority Data
Mar. 17, 2022 (JP) 2022-042104

(51) Int. Cl. H02K 1/276

(52) U.S. Cl. CPC H02K 1/276; H02K 2213/03

(57) ABSTRACT

The present disclosure provides a rotor capable of increasing torque by suppressing an increase in a magnetic resistance when a gap exists between a rotor core and a permanent magnet housed in a slot of the rotor core. The rotor core forming the rotor includes one or more first electromagnetic steel sheets and one or more second electromagnetic steel sheets alternately stacked. The first electromagnetic steel sheet includes a plurality of first slot holes forming a plurality of slots in the rotor core. The second electromagnetic steel sheet includes a plurality of second slot holes forming the plurality of slots in the rotor core and a cut-out portion provided in a part of a peripheral wall of the second slot hole and forming a gap between the rotor core and a pole face, the peripheral wall facing the pole face of the permanent magnet housed in each slot.

### CROSS REFERENCE TO RELATED APPLICATIONS

The present application claims priority from Japanese patent application JP 2022-042104 filed on Mar. 17, 2022, the entire content of which is hereby incorporated by reference into this application.

### BACKGROUND

### Technical Field

The present disclosure relates to a rotor.

### Background Art

Permanent-magnet-embedded electric motors have conventionally been known. A permanent-magnet-embedded electric motor described in JP 2016-7136 A includes a stator having a coil wound on a stator core and a rotor disposed rotatably via a gap formed with an inner circumferential surface of the stator core (abstract, paragraphs 0008-0011, claim 1, and the like).

The aforementioned rotor includes a rotor core formed of stacked steel plates having a plurality of magnet-embedding holes, and a permanent magnet housed and retained in each of the magnet-embedding holes. Further, the outer circumferential surface of the rotor is formed of a first curved section that faces near the center part of the aforementioned permanent magnet and that has a center point on the center side of the rotor, and a second curved section that connects to the opposite sides of the first curved section and that has a radius smaller than a radius of the first curved section.

The aforementioned steel plates have bridge portions that are formed between edges of the magnet-embedding holes and the outer circumference of the steel plates, and the plate thickness of each bridge portion is formed thinner than the plate thickness of the part other than the bridge portions. In addition, adjoining bridge portions are connected with a thinned link portion having a plate thickness that is made thinner, through press machining, than the plate thickness of the part other than the bridge portions. Further, when the plate thickness of the bridge portion is defined as d2, the width in the radial direction is defined as t1, and the plate thickness of the steel plate is defined as d1, d2≤t1≤d1 is satisfied. The bridge portions are only provided between adjoining permanent magnets, and are not provided on the outer circumference side in the radial direction relative to the permanent magnets.

A magnetic flux produced by the permanent magnet passes through the bridge portion and flows to the adjoining permanent magnet, and a magnetic resistance in the entire magnetic path does not increase when the plate thickness of only the bridge portion is reduced. Therefore, the magnetic flux leakage can be reduced by connecting the bridge portions with a thinned plate thickness by means of the thinned link portion, so as to increase the magnetic resistance in the entire magnetic path.

Further, a rotor described in WO 2011/125183 A1 includes a rotor core formed by stacking a plurality of electromagnetic steel plates, a plurality of slots which is arranged at equiangular intervals on the outer circumferential portion of the rotor core and extends through the rotor core in the axial direction, and permanent magnets which are assembled in each of the plurality of slots (abstract, paragraph 0007, and claim 1).

In this rotor, in the plurality of electromagnetic steel plates, a plurality of slot-holes which has the same shape and which forms the plurality of slots is formed at equiangular intervals in the outer circumferential portion, and protrusions are formed in the inner edges of the plurality of slot-holes. The plurality of electromagnetic steel plates is stacked so that, between electromagnetic steel plates which are vertically adjacent, specified slot-holes having the protrusions are staggered in the circumferential direction by a specified phase-shift amount. Thus, a plurality of protrusions in every slot is arranged at intervals in the axial direction of the slot. The permanent magnets are fixed in every slot so as to contact and deform the plurality of protrusions.

According to this rotor, since the plurality of electromagnetic steel plates that form the rotor core has the same shape, electromagnetic steel plates in different shapes need not be individually produced. Further, since the plurality of protrusions in every slot is arranged at intervals in the axial direction of the slot, a space for deforming each protrusion in the axial direction of the slot is secured, unlike a case in which the protrusions are stacked and arranged without intervals in the axial direction of the slot, and the load exerted in press-fitting of the permanent magnet into the slot is reduced.

### SUMMARY

In the electric motor of JP 2016-7136 A, the magnet-embedding hole has a cross-sectional shape that includes a magnet-housing space, first gap portions on the opposite sides, and second gap portions on the opposite sides (paragraph 0022, and FIG. 2A and FIG. 2B). The second gap portions formed between a part of the pole face of each permanent magnet and the rotor core improve the property of filling resin to fix the permanent magnet and contribute to the improvement in the property of fixing the permanent magnet, but on the other hand, the second gap portions increase the magnetic resistance to thus reduce the magnetic flux amount of the magnet, which causes the torque of the electric motor to decrease.

Further, the rotor of WO 2011/125183 A1 can fix each permanent magnet in each slot by means of the plurality of protrusions in the slot, but the increase in the magnetic resistance due to the gap formed between a part of the pole faces of each permanent magnet and the rotor core cannot be suppressed.

The present disclosure provides a rotor capable of increasing torque by suppressing an increase in a magnetic resistance when a gap exists between a rotor core and a part of a pole face of each permanent magnet housed in each slot of the rotor core.

One aspect of the present disclosure is a rotor that includes: a rotor core, a plurality of slots provided in the rotor core, a plurality of permanent magnets, one or more of the plurality of permanent magnets being housed in each of the plurality of slots, and a gap formed between at least one of pole faces of each of the plurality of permanent magnets and the rotor core, in which the rotor core includes one or more first electromagnetic steel sheets and one or more second electromagnetic steel sheets alternately stacked, each of the one or more first electromagnetic steel sheets has a plurality of first slot holes to form the plurality of slots, and each of the one or more second electromagnetic steel sheets has a plurality of second slot holes to form the plurality of slots and a cut-out portion provided in a part of a peripheral wall of each of the plurality of second slot holes and forming the gap, the peripheral wall facing the pole faces of each of the permanent magnets.

In the rotor of the aforementioned one aspect, the rotor core includes the one or more first electromagnetic steel sheets and the one or more second electromagnetic steel sheets alternately stacked in the rotation axis direction parallel to the rotating shaft of the rotor, namely, in the thickness direction of the rotor core. Specifically, the configuration of the rotor core includes those in which the first electromagnetic steel sheets and the second electromagnetic steel sheets are alternately stacked one by one, one of the first electromagnetic steel sheets and the plurality of second electromagnetic steel sheets are alternately stacked, the plurality of first electromagnetic steel sheets and the plurality of second electromagnetic steel sheets are alternately stacked, and the plurality of first electromagnetic steel sheets and one of the second electromagnetic steel sheets are alternately stacked.

The first electromagnetic steel sheet and the second electromagnetic steel sheet have the same configuration, except that each first slot hole provided in the first electromagnetic steel sheet does not have a cut-out portion, while each second slot hole provided in the second electromagnetic steel sheet has the cut-out portion. With the plurality of first electromagnetic steel sheets and the plurality of second electromagnetic steel sheets stacked to form the rotor core, the plurality of first slot holes and the plurality of second slot holes are coupled in the rotation axis direction of the rotor core so as to form the plurality of slots extending through the rotor core in the thickness direction.

The cut-out portion of the second electromagnetic steel sheet forms a gap between at least one of a pair of pole faces of the permanent magnet inserted into each slot and the rotor core, with the one or more first electromagnetic steel sheets and the one or more second electromagnetic steel sheets alternately stacked. Specifically, the gap between the rotor core and at least one of the pole faces of each permanent magnet is formed in a portion where the one or more second electromagnetic steel sheets are stacked in the rotation axis direction of the rotor, but is not formed in a portion where the one or more first electromagnetic steel sheets are stacked. Note that the pole face of the permanent magnet is an end face crossing or orthogonal to the magnetic flux and where the magnetic poles appear.

With such a configuration, an uncured curable resin can be filled and cured in the gap between the rotor core and the pole face of each permanent magnet in the portion where the one or more second electromagnetic steel sheets are stacked in the rotor core. Therefore, a favorable property of fixing each permanent magnet inserted into each slot of the rotor core can be secured. Further, the gap between the rotor core and the pole face of each permanent magnet is eliminated in the portion where the one or more first electromagnetic steel sheets are stacked in the rotor core to thus suppress the increase in the magnetic resistance, so that the torque can be increased.

In the rotor of the aforementioned aspect, as described above, the rotor core may be configured with a stack of the plurality of first electromagnetic steel sheets and the plurality of second electromagnetic steel sheets, formed by alternately stacking the first electromagnetic steel sheets and the second electromagnetic steel sheets one by one.

With such a configuration, on the pole face of each permanent magnet, a region where a gap does not exist between the pole face and the rotor core can be more uniformly and broadly expanded, so that the effect of reducing the magnetic resistance can be further improved. Meanwhile, on the pole face of each permanent magnet, a region where a gap exists between the pole face and the rotor core can be more uniformly and broadly expanded. Thus, with the curable resin filled in each gap, the property of fixing each permanent magnet inserted into each slot of the rotor core can be improved.

In the rotor of the aforementioned aspect, when a thickness of each of the second electromagnetic steel sheets is defined as t, a total thickness of the one or more second electromagnetic steel sheets that are alternately stacked with the one or more first electromagnetic steel sheets is defined as T, and a size of the gap in a direction along a magnetic flux of each of the permanent magnets is defined as s, a relation of T≤2s and t≤s may be satisfied.

With such a configuration, the permanent magnet can entirely obtain the effect of reducing the demagnetizing field to thus enable to improve the effect of reducing the magnetic resistance. More specifically, the permanent magnet has the minimum demagnetizing field in the portion where the gap does not exist between the permanent magnet and the rotor core, and the demagnetizing field increases in the portion where the gap exists between the permanent magnet and the rotor core, as the portion where the gap exists is distanced farther, in the rotation axis direction of the rotor core, from the portion where the gap does not exist between the permanent magnet and the rotor core.

Further, in the permanent magnet, the effect of reducing the demagnetizing field cannot be obtained in a portion where the gap exists between the permanent magnet and the rotor core that is distanced, by a distance greater than a size s of the gap, in the rotation axis direction of the rotor core, from the portion where the gap does not exist between the permanent magnet and the rotor core. Meanwhile, when the total thickness T of the one or more second electromagnetic steel sheets that are alternately stacked with the one or more first electromagnetic steel sheets is set to be twice or less than twice the aforementioned size s of the gap, the permanent magnet can entirely obtain the effect of reducing the demagnetizing field in the rotation axis direction of the rotor.

Further, when the thickness t of each second electromagnetic steel sheet is greater than the aforementioned size s of the gap, even in a case where the one or more first electromagnetic steel sheets and one of the second electromagnetic steel sheets are alternately stacked, some portions may fail to obtain the effect of reducing the demagnetizing field in each permanent magnet for the aforementioned reasons. Meanwhile, when the thickness t of each second electromagnetic steel sheet is equal to or smaller than the aforementioned size s of the gap, in a case where the one or more first electromagnetic steel sheets and one of the second electromagnetic steel sheets are alternately stacked, the permanent magnet can entirely obtain the effect of reducing the demagnetizing field in the rotation axis direction of the rotor.

According to each of the aforementioned aspects of the present disclosure, a rotor can be provided in which when a gap exists between the rotor core and the pole faces of each permanent magnet housed in each slot of the rotor core, the increase in the magnetic resistance can be suppressed to thus increase the torque.

### BRIEF DESCRIPTION OF THE DRAWINGS

FIG. 1 is a longitudinal cross-sectional view of a motor showing an embodiment of a rotor according to the present disclosure;

FIG. 2 is a transverse cross-sectional view of the rotor and a stator of the motor shown in FIG. 1;

FIG. 3 is an enlarged view of a pair of permanent magnets housed in a pair of slots of the rotor shown in FIG. 2;

FIG. 4 is a schematic cross-sectional view of the rotor taken along line IV-IV of FIG. 3;

FIG. 5 is a graph comparing the torque between the motor of the present embodiment shown in FIG. 1 and a motor of a comparative example;

FIG. 6 is a graph showing the rate of reduction of the demagnetizing field in the pair of permanent magnets shown in FIG. 3;

FIG. 7 shows the demagnetizing field in the pair of permanent magnets shown in FIG. 3;

FIGS. 8A to 8D show enlarged views of modifications of a cut-out portion of a second electromagnetic steel sheet forming a rotor core of FIG. 3;

FIGS. 9A to 9C show enlarged cross-sectional views of modifications of the rotor shown in FIG. 2 corresponding to FIG. 4; and

FIG. 10 is an enlarged cross-sectional view corresponding to FIG. 4, showing an example of dimensional relations of the rotor shown in FIG. 2.

### DETAILED DESCRIPTION

Hereinafter, an embodiment of a rotor according to the present disclosure will be described with reference to the drawings.

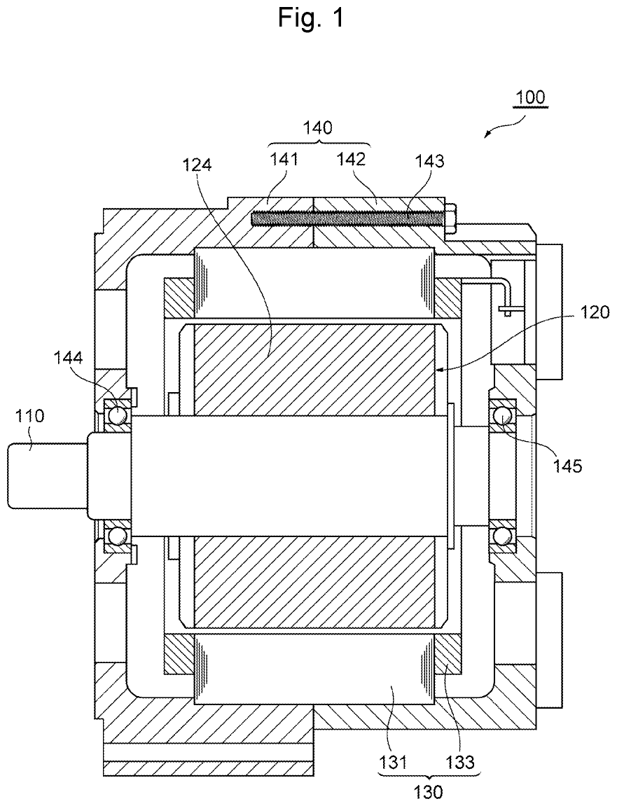

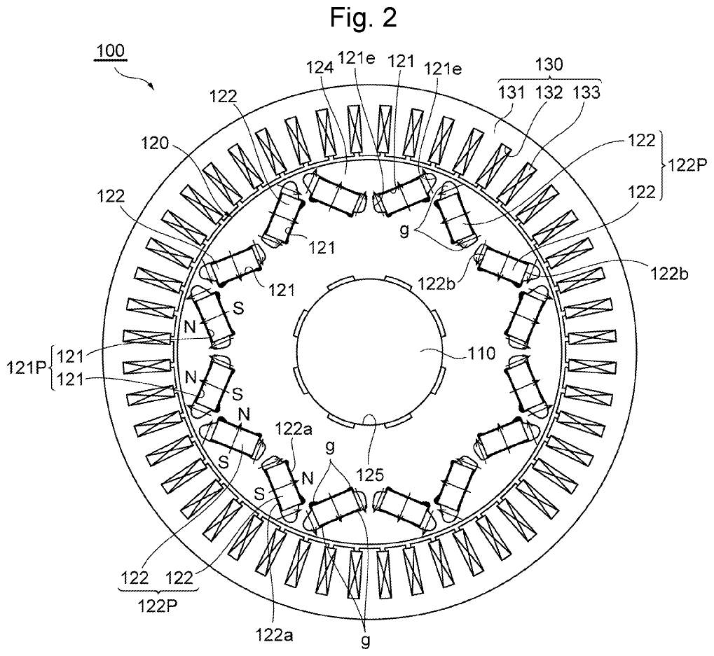

FIG. 1 is a longitudinal cross-sectional view of a motor 100 showing an embodiment 1 of a rotor according to the present disclosure. FIG. 2 is a transverse cross-sectional view of a rotor 120 and a stator 130 in a cross section orthogonal to a rotating shaft 110 of the motor 100 shown in FIG. 1. The following descriptions will be made assuming that a direction parallel to the rotating shaft 110 is a rotation axis direction, a direction parallel to the diameter of the circumference about the rotating shaft 110 is a radial direction, and a direction along the circumference about the rotating shaft 110 is a circumferential direction.

The motor 100 is, for example, an IPM (Interior Permanent Magnet) motor that is mounted on a vehicle, such as a hybrid vehicle, an electric vehicle, or a hydrogen vehicle, and that generates a driving force to drive the vehicle. The motor 100 includes, for example, the rotating shaft 110, the rotor 120 fixed to the rotating shaft 110, the stator 130 disposed around the rotor 120, and a housing 140 that houses the rotor 120 and the stator 130.

The rotor 120 is cylindrically provided, for example. The stator 130 is annularly or cylindrically provided, for example, and is disposed radially outside the rotor 120 so as to surround the rotor 120. The rotor 120 and the stator 130 are coaxially disposed and an outer circumferential surface of the rotor 120 and an inner circumferential surface of the stator 130 radially face each other. A predetermined air gap is formed between the outer circumferential surface of the rotor 120 and the inner circumferential surface of the stator 130.

The housing 140 includes, for example, a pair of housing members 141, 142 in a bottomed cylindrical shape. The pair of housing members 141, 142 are integrally formed with their openings joined together by being fastened with a fastening member such as a bolt 143. The housing 140 includes bearings 144, 145 that rotatably support the rotating shaft 110 and the rotor 120.

As shown in FIG. 2, the rotor 120 includes, for example, a rotor core 124, a plurality of slots 121 provided in the rotor core 124, and a plurality of permanent magnets 122, each one of the permanent magnets 122 housed in each of the plurality of slots 121. Note that the permanent magnet 122 housed in each slot 121 may be several pieces of divided magnets. In this case, the plurality of permanent magnets is housed in each of the plurality of slots 121. Further, the rotor 120 has a gap g formed between at least one of pole faces 122a of each of the plurality of permanent magnets 122 and the rotor core 124.

A pair 121P of the plurality of slots 121 provided in the rotor core 124 are arranged equidistantly in the circumferential direction of the rotor 120, in a V-shape opened outward in the radial direction of the rotor 120, for example. Each slot 121 provided in the rotor core 124 has a rectangular shape as viewed from the rotation axis direction, and has extended portions 121e on the opposite end portions in the circumferential direction of the rotor 120.

The pair of extended portions 121e of the slot 121 are, for example, extended portions of the opposite ends of the slot 121 in the longitudinal direction of the permanent magnet 122 having a rectangular transverse section. In the pair of extended portions 121e, the gap g is formed between each of a pair of side faces 122b on the opposite sides of the pair of pole faces 122a of the permanent magnet 122 and the rotor core 124.

Each permanent magnet 122 has, for example, the pair of pole faces 122a at the opposite ends in the lateral direction of the rectangular transverse section. The pair of pole faces 122a are faces orthogonal to or crossing the magnetic flux in each permanent magnet 122 and where the magnetic poles appear. A pair 122P of the permanent magnets 122 are housed in the pair 121P of the plurality of slots 121, with the polarity alternately inverted such that the north pole and the south pole of the pole faces 122a alternately face outward in the radial direction in the circumferential direction.

Each permanent magnet 122 is inserted into each slot 121 and is fixed to the rotor core 124 such that an uncured curable resin filled in each gap g is cured. The pair 122P of the permanent magnets 122 with the north pole oriented outward in the radial direction are arranged axisymmetrically about the north pole center line extending in the radial direction of the rotor 120. Further, the pair 122P of the permanent magnets 122 with the south pole oriented outward in the radial direction are arranged axisymmetrically about the south pole center line extending in the radial direction of the rotor 120.

As the material of the permanent magnet 122, a metal magnetic material including a neodymium sintered magnet may be used. The neodymium magnet that may be used includes a rare earth, such as Nd, Dy, and Tb, but is not particularly limited, and other rare earths, such as Ce, Pr, Pm, Sm, Eu, Gd, Tb, Dy, Ho, Er, Tm, Yb, and Lu, may be used.

The stator 130 includes, for example, a cylindrical stator core 131 including stacked multiple electromagnetic steel sheets. The stator core 131 includes a plurality of slots 132 equidistantly provided in the circumferential direction. The slots 132 axially extend through the stator core 131. The slots 132 have a three-phase stator coil 133 wound and disposed therein, for example. In the present embodiment, 48 of the slots 132 are equidistantly arranged in the circumferential direction, for example, such that the three-phase stator coils 133 are housed so as to correspond to the magnetic poles of the rotor 120 in number.

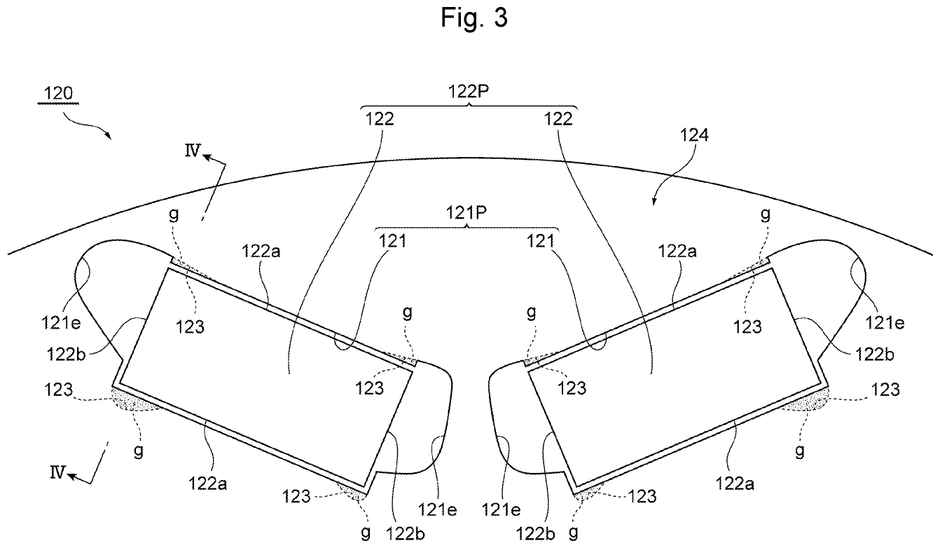

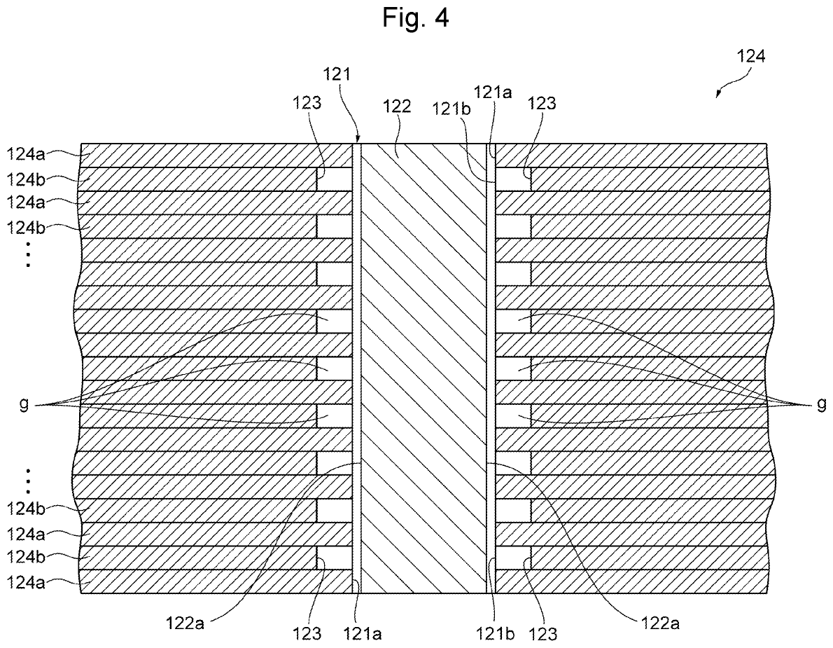

FIG. 3 is a schematic enlarged view of one pair 122P of the permanent magnets 122 housed in one pair 121P of the slots 121 provided in the rotor core 124 forming the rotor 120 shown in FIG. 2. FIG. 4 is a schematic cross-sectional view of the rotor 120 taken along line IV-IV of FIG. 3.

The rotor core 124 includes one or more first electromagnetic steel sheets 124a and one or more second electromagnetic steel sheets 124b that are alternately stacked. In the rotor 120 of the present embodiment, as shown in FIG. 4, the rotor core 124 is configured with a stack of the plurality of first electromagnetic steel sheets 124a and the plurality of second electromagnetic steel sheets 124b, formed by alternately stacking the first electromagnetic steel sheets and the second electromagnetic steel sheets one by one.

The first electromagnetic steel sheets 124a each include a plurality of first slot holes 121a that forms the plurality of slots 121 when stacked. The second electromagnetic steel sheets 124b each include a plurality of second slot holes 121b that forms the plurality of slots 121 when stacked and a cut-out portion 123 provided in a part of a peripheral wall of each of the plurality of second slot holes 121b and forming the gap g, the peripheral wall facing the pole faces 122a of each permanent magnet 122.

With the plurality of first electromagnetic steel sheets 124a and the plurality of second electromagnetic steel sheets 124b stacked to form the rotor core 124, the plurality of first slot holes 121a and the plurality of second slot holes 121b are coupled in the rotation axis direction of the rotor core 124. In this manner, the plurality of first slot holes 121a of each of the plurality of first electromagnetic steel sheets 124a and the plurality of second slot holes 121b of each of the plurality of second electromagnetic steel sheets 124b form the plurality of slots 121 extending through the rotor core 124 in the thickness direction.

A clearance between the slot 121 and the permanent magnet 122 is set to be, for example, within a range that allows insertion of the permanent magnet 122 into the slot 121, considering the dimension tolerance of the slot 121 and the dimension tolerance of the permanent magnet 122. The clearance between the slot 121 and the permanent magnet 122 is smaller than the size of the cut-out portion 123 in the magnetic flux direction of the permanent magnet 122, and is, for example, smaller than the thickness of each of the first electromagnetic steel sheet 124a and the second electromagnetic steel sheet 124b.

The first electromagnetic steel sheet 124a and the second electromagnetic steel sheet 124b differ in that the first slot hole 121a provided in the first electromagnetic steel sheet 124a does not have the cut-out portion 123, while the second slot hole 121b provided in the second electromagnetic steel sheet 124b has the cut-out portion 123. Except for the difference, the first electromagnetic steel sheet 124a and the second electromagnetic steel sheet 124b are the same in configuration, including the material, size, and shape. The first electromagnetic steel sheet 124a and the second electromagnetic steel sheet 124b are, for example, a thin plate of a soft magnetic material having a thickness of about 0.2 mm to about 0.5 mm.

In an example shown in FIG. 3, in the second electromagnetic steel sheet 124b, the peripheral wall of the second slot hole 121b facing the pair of pole faces 122a of the permanent magnet 122 includes a pair of flat surfaces. The pair of flat surfaces of the peripheral wall of the second slot hole 121b include, for example, a pair of cut-out portions 123 at each of one end and the other end in the longitudinal direction of the rectangular transverse section of the permanent magnet 122. The cut-out portion 123 adjacent to the pole face 122a of the permanent magnet 122 facing outward in the radial direction of the rotor core 124 has a size along the magnetic flux direction of the permanent magnet 122 smaller than that of the cut-out portion 123 adjacent to the pole face 122a of the permanent magnet 122 facing inward in the radial direction of the rotor core 124, for example.

The pole face 122a of the north pole of the permanent magnet 122 faces, for example, outward in the radial direction of the rotor core 124, and the pole face 122a of the south pole of the permanent magnet 122 faces, for example, inward in the radial direction of the rotor core 124. In this case, the gap g between the pole face 122a of the north pole of the permanent magnet 122 and the rotor core 124 is smaller than the gap g between the pole face 122a of the south pole of the permanent magnet 122 and the rotor core 124.

Note that the pole face 122a of the north pole of the permanent magnet 122 may face, for example, inward in the radial direction of the rotor core 124 and the pole face 122a of the south pole of the permanent magnet 122 may face, for example, outward in the radial direction of the rotor core 124. In this case, the gap g between the pole face 122a of the south pole of the permanent magnet 122 and the rotor core 124 is smaller than the gap g between the pole face 122a of the north pole of the permanent magnet 122 and the rotor core 124.

The plurality of first electromagnetic steel sheets 124a and the plurality of second electromagnetic steel sheets 124b are stacked, and an uncured curable resin is filled in and the permanent magnet 122 is inserted into each of the plurality of slots 121. In this manner, the uncured curable resin is filled between each permanent magnet 122 and the peripheral wall of each slot 121 and in at least one cut-out portion 123 provided in each second slot hole 121b of the second electromagnetic steel sheet 124b. Subsequently, the uncured curable resin is cured, so that each permanent magnet 122 inserted into each slot 121 is fixed to the rotor core 124.

Hereinafter, the function of the rotor 120 of the present embodiment will be described based on the comparison between the conventional permanent-magnet-embedded electric motor and the rotor.

The magnet-embedding hole of the conventional electric motor described in JP 2016-7136 A has a cross-sectional shape that includes the magnet-housing space, the first gap portions, and the second gap portions, as described above. The second gap portions formed between a part of the pole faces of each permanent magnet and the rotor core improve the property of filling resin to fix the permanent magnet and contribute to the improvement in the property of fixing the permanent magnet, but on the other hand, the second gap portions increase the magnetic resistance to thus reduce the magnetic flux amount of the magnet, which causes the torque of the electric motor to decrease. Further, the conventional rotor described in WO 2011/125183 A1 can fix each permanent magnet in each slot by means of the plurality of protrusions in the slot, but the increase in the magnetic resistance due to the gap formed between a part of the pole faces of each permanent magnet and the rotor core cannot be suppressed.

By contrast, as described above, the rotor 120 of the present embodiment includes the rotor core 124, the plurality of slots 121 provided in the rotor core 124, and the plurality of permanent magnets 122, one or more of which are housed in each of the plurality of slots 121. Further, the rotor 120 has the gap g formed between at least one of the pole faces 122a of each of the plurality of permanent magnets 122 and the rotor core 124. The rotor core 124 includes the one or more first electromagnetic steel sheets 124a and the one or more second electromagnetic steel sheets 124b that are alternately stacked. The one or more first electromagnetic steel sheets 124a each include the plurality of first slot holes 121a that forms the plurality of slots 121. The one or more second electromagnetic steel sheets 124b each include the plurality of second slot holes 121b that forms the plurality of slots 121, and the cut-out portion 123 provided in a part of the peripheral wall of each of the plurality of second slot holes 121b and forming the gap g, the peripheral wall facing the pole faces 122a of each permanent magnet 122.

With such a configuration, the rotor 120 of the present embodiment allows the uncured curable resin to be filled and cured in the gap g between the rotor core 124 and the pole faces 122a of each permanent magnet 122 in the portion where the one or more second electromagnetic steel sheets 124b are stacked in the rotor core 124. Therefore, a favorable property of fixing each permanent magnet 122 inserted into each slot 121 of the rotor core 124 can be secured. Further, the gap g between the rotor core 124 and the pole faces 122a of each permanent magnet 122 is eliminated in the portion where the one or more first electromagnetic steel sheets 124a are stacked in the rotor core 124 to thus suppress the increase in the magnetic resistance, so that the torque of the motor 100 can be increased.

FIG. 5 is a graph comparing the torque of the motor 100 of the present embodiment shown in FIG. 1 and the torque of a motor of a comparative example (not shown). Herein, the motor of the comparative example differs from the motor 100 of the present embodiment only in the configuration of the rotor. The rotor used in the motor of the comparative example is the same as the rotor 120 of the present embodiment in configuration, except that only the plurality of second electromagnetic steel sheets 124b are stacked without using the first electromagnetic steel sheets 124a shown in FIG. 4. Specifically, the gap g between the pole face 122a of the permanent magnet 122 and the rotor core 124 in the rotor of the comparative example extends continuously through the rotor core 124 in the thickness direction in the rotation axis direction.

As shown in FIG. 5, the torque of the motor 100 including the rotor 120 of the present embodiment increases by approximately 0.25% as compared to the motor of the comparative example. Specifically, the rotor core 124 of the present embodiment can reduce the magnetic resistance in the portion where the one or more first electromagnetic steel sheets 124a are stacked to thus increase the magnetic flux amount of the magnet, so that the torque of the motor 100 can be increased.

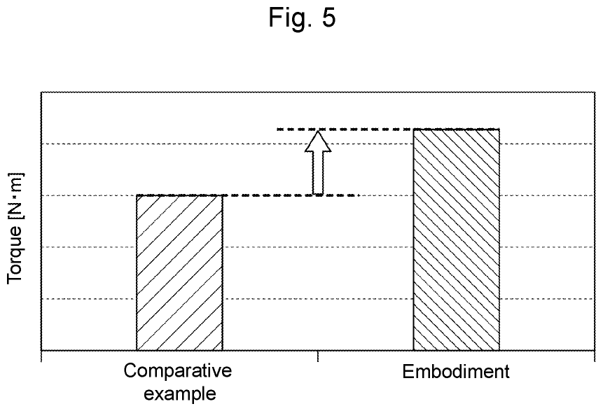

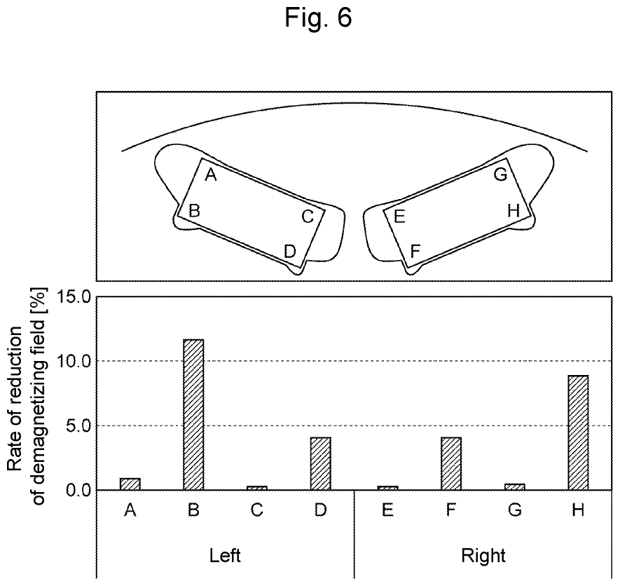

FIG. 6 is a graph showing the rate of reduction of the demagnetizing field in the pair 122P of the permanent magnets 122 arranged in a V-shape of FIG. 3. FIG. 6 shows the rate of reduction of the demagnetizing field in positions from position A to position H in the pair 122P of the permanent magnets 122. As shown in FIG. 6, the positions A to D are on the permanent magnet 122 on the left side and the positions E to H are on the permanent magnet 122 on the right side.

The position A and the position G are on the outer side in the radial direction and the outer side in the circumferential direction of the rotor core 124 in the pair 122P of the permanent magnets 122 arranged in a V-shape. The gap g in each of the position A and the position G is smaller than the gap g in each of the position B, position D, position F, and position H on the inner side in the radial direction of the rotor core 124. The position B and the position H are on the inner side in the radial direction and on the outer side in the circumferential direction of the rotor core 124 in the pair 122P of the permanent magnets 122 arranged in a V-shape. The gap g in each of the position B and the position H is the largest among the gaps g in the positions A to H.

The position C and the position E are on the outer side in the radial direction and on the inner side in the circumferential direction of the rotor core 124 in the pair 122P of the permanent magnets 122 arranged in a V-shape. The gap g in each of the position C and the position E is smaller than the gap g in each of the position B, position D, position F, and position H on the inner side in the radial direction of the rotor core 124. The position D and the position F are on the inner side in the radial direction and on the inner side in the circumferential direction of the rotor core 124 in the pair 122P of the permanent magnets 122 arranged in a V-shape. The gap g in each of the position D and the position F is the second largest following the gap g in each of the position B and the position H.

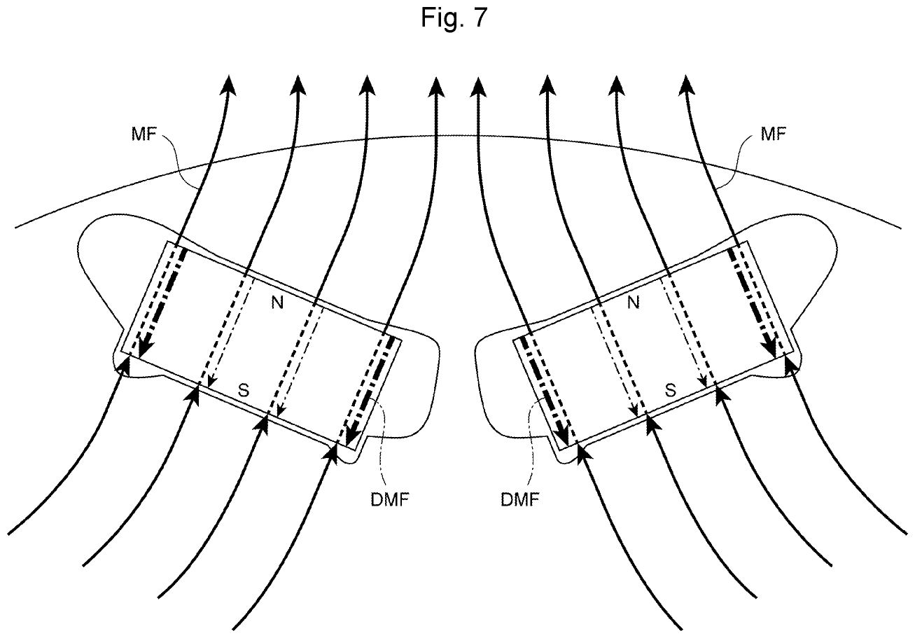

FIG. 7 shows a demagnetizing field DMF in the pair 122P of the permanent magnets 122 arranged in a V-shape of FIG. 3. FIG. 7 shows a case in which the pole face 122a on the outer side of the pair 122P of the permanent magnets 122 in the radial direction of the rotor core 124 is the north pole. In this case, a magnetic flux MF passing outside the permanent magnet 122 moves from the north pole of the pair 122P of the permanent magnets 122 toward the stator 130 to pass through the stator 130 and the rotor core 124, and then returns to the south pole.

The demagnetizing field DMF is a magnetic field moving from the north pole toward the south pole inside each permanent magnet 122. The demagnetizing field DMF tends to intensify as the gap g between the pole face 122a of each permanent magnet 122 and the rotor core 124 increases. The same tendency can be seen in a case in which the pole face 122a on the outer side of the pair 122P of the permanent magnets 122 in the radial direction of the rotor core 124 is the south pole. As the demagnetizing field DMF intensifies, the magnetic resistance increases to thus reduce the magnetic flux amount of the magnet.

The rate of reduction of the demagnetizing field in the graph of FIG. 6 can be obtained as follows. First, the intensity of the demagnetizing field DMF in the positions from the position A to the position H of the pair 122P of the permanent magnets 122 fixed to the aforementioned rotor core of the comparative example is obtained using the magnetic field analysis. As described above, the rotor core of the comparative example includes only the second electromagnetic steel sheets 124b stacked without using the first electromagnetic steel sheets 124a shown in FIG. 4, and the gap g between the pole face 122a of the permanent magnet 122 and the rotor core extends through the rotor core in the thickness direction.

Next, the intensity of the demagnetizing field DMF in the positions from the position A to the position H of the pair 122P of the permanent magnets 122 fixed to the rotor core 124 of the present embodiment is obtained using the magnetic field analysis, and the rate of reduction of the demagnetizing field is obtained for each position from the position A to the position H based on the demagnetizing field DMF of the rotor core of the comparative example as a reference. As a result, as shown in FIG. 6, a high rate of reduction of the demagnetizing field of around 10% is attained in the position B and the position H where the gap g is the largest.

Further, in the position D and the position F where the gap g is the second largest following the position B and the position H, the rate of reduction of the demagnetizing field of around 4% is attained. Meanwhile, in the position A, position C, position E, and the position G where the gap g is smaller than those in the position D and the position F, the rate of reduction of the demagnetizing field remains around 1% or lower. Specifically, in the rotor core 124 of the present embodiment, as the gap g between the pole face 122a of the permanent magnet 122 and the rotor core 124 increases, the rate of reduction of the demagnetizing field increases to thus reduce the magnetic resistance, so that the effect of increasing the magnetic flux amount of the magnet is improved.

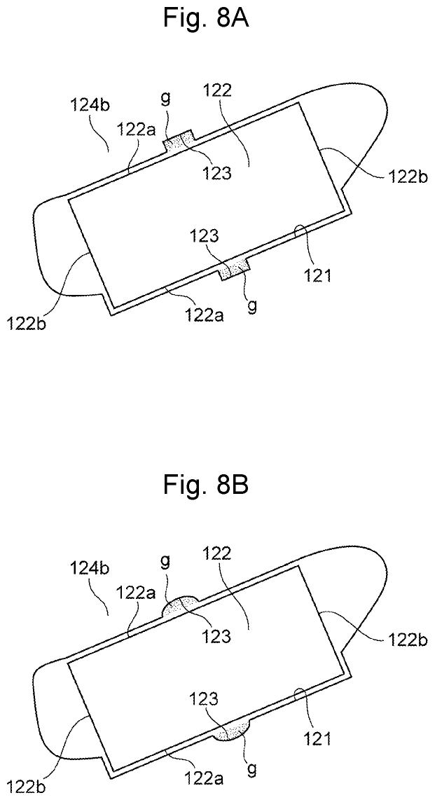

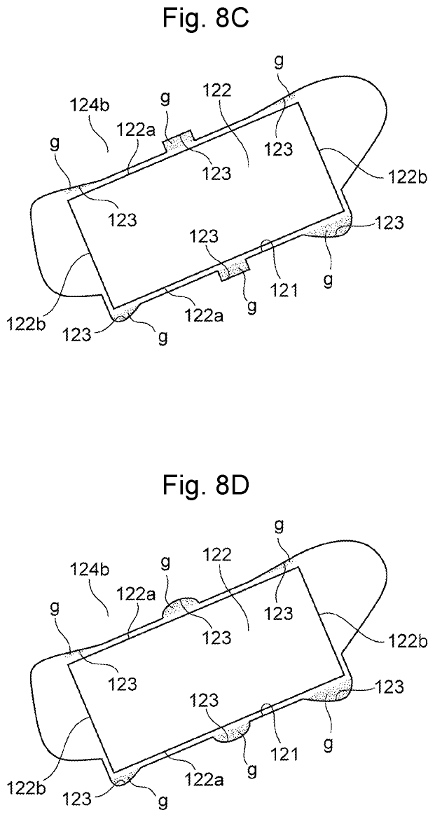

Note that the position, shape, and size of the gap g between the pole face 122a of the permanent magnet 122 and the rotor core 124 is not limited to those of the example shown in FIG. 3. FIGS. 8A to 8D show enlarged cross-sectional views of modifications of the cut-out portion 123 of the second electromagnetic steel sheet 124b forming the rotor core 124 of FIG. 3.

As shown in the modifications in FIGS. 8A to 8D, the cut-out portion 123 may be provided in a middle portion in the longitudinal direction on the rectangular transverse cross section of the permanent magnet 122 on the flat surface of the peripheral wall of the slot 121 facing the pole faces 122a of the permanent magnet 122. Specifically, the gap g may be formed between the pole face 122a of the permanent magnet 122 and the rotor core 124 in the middle portion in the longitudinal direction on the rectangular transverse cross section of the permanent magnet 122. Further, the cut-out portion 123 and the gap g may have a transverse cross section in any shape, such as a semi-circular, a semi-elliptical, a rectangular, or a triangular shape.

Further, in the rotor 120 of the present embodiment, as shown in FIG. 4, the rotor core 124 is configured with a stack of the plurality of first electromagnetic steel sheets 124a and the plurality of second electromagnetic steel sheets 124b, formed by alternately stacking the first electromagnetic steel sheets 124a and the second electromagnetic steel sheets 124b one by one. With such a configuration, on the pole face 122a of each permanent magnet 122, a region where the gap g does not exist between the pole face 122a and the rotor core 124 can be more uniformly and broadly expanded, so that the effect of reducing the magnetic resistance can be further improved.

Furthermore, on the pole face 122a of each permanent magnet 122, a region where the gap g exists between the pole face 122a and the rotor core 124 can be more uniformly and broadly expanded. Thus, with the curable resin filled in each gap g, the property of fixing each permanent magnet 122 inserted into each slot 121 of the rotor core 124 can be improved. Note that the configuration of the rotor 120 of the present embodiment is not limited to that shown in FIG. 4.

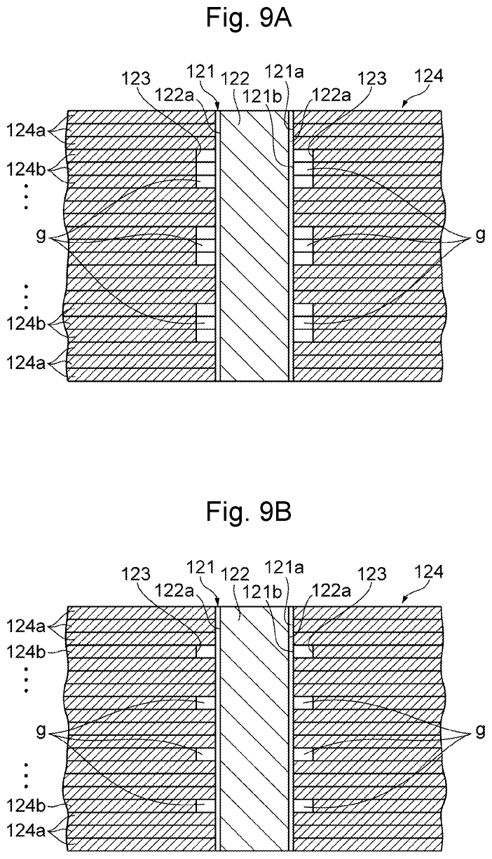

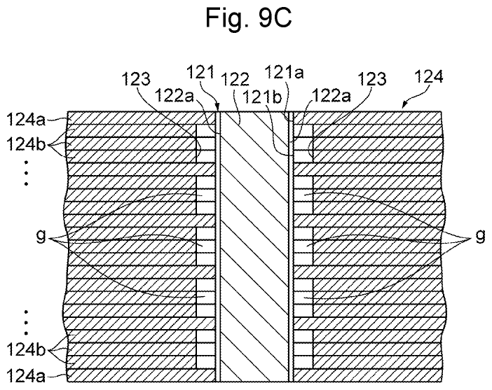

FIGS. 9A to 9C show enlarged cross-sectional views of modifications of the rotor 120 of the present embodiment corresponding to FIG. 4. In the rotor 120 of the modification in FIG. 9A, the rotor core 124 includes the plurality of first electromagnetic steel sheets 124a and the plurality of second electromagnetic steel sheets 124b alternately stacked. In the rotor 120 of the modification in FIG. 9B, the rotor core 124 includes the plurality of first electromagnetic steel sheets 124a and one of the second electromagnetic steel sheets 124b alternately stacked.

In the rotor 120 of the modification in FIG. 9C, the rotor core 124 includes one of the first electromagnetic steel sheets 124a and the plurality of second electromagnetic steel sheets 124b alternately stacked. Specifically, in the rotor 120 of the present embodiment, the rotor core 124 includes the one or more first electromagnetic steel sheets 124a and the one or more second electromagnetic steel sheets 124b alternately stacked in the rotation axis direction parallel to the rotating shaft of the rotor 120, namely, in the thickness direction of the rotor core 124.

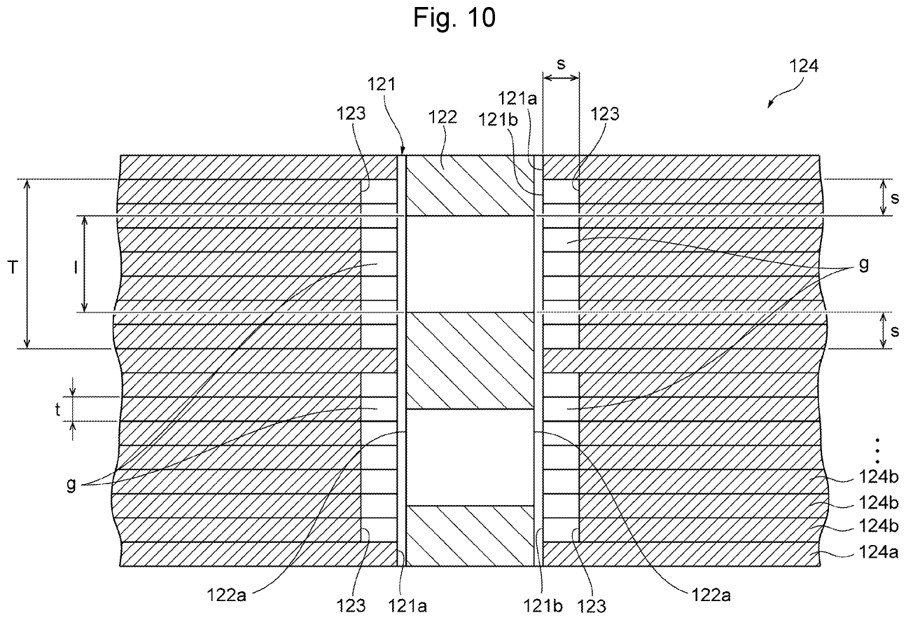

FIG. 10 is an enlarged cross-sectional view corresponding to FIG. 4, showing an example of dimensional relations of the rotor 120 of the present embodiment. The thickness of each of the second electromagnetic steel sheets 124b forming the rotor core 124 of the rotor 120 is defined as t, and the total thickness of the one or more second electromagnetic steel sheets 124b that are alternately stacked with the one or more first electromagnetic steel sheets 124a is defined as T. Further, the size of the gap g in a direction along the magnetic flux of each permanent magnet 122 is defined as s. At this time, for example, the relation of T≤2s and t≤s is satisfied.

With such a configuration, the permanent magnet 122 can entirely obtain the effect of reducing the demagnetizing field to thus enable to improve the effect of reducing the magnetic resistance. More specifically, the permanent magnet 122 has the minimum demagnetizing field in the portion where the gap g does not exist between the permanent magnet 122 and the rotor core 124, and the demagnetizing field increases in the portion where the gap g exists between the permanent magnet 122 and the rotor core 124, as the portion where the gap g exists is distanced farther, in the rotation axis direction of the rotor core 124, from the portion where the gap g does not exist between the permanent magnet 122 and the rotor core 124.

Further, in the permanent magnet 122, in the portion where the gap g exists between the permanent magnet 122 and the rotor core 124, the effect of reducing the demagnetizing field cannot be obtained in an outlined portion that is distanced, by a distance greater than the size s of the gap g, in the rotation axis direction of the rotor core 124, from the first electromagnetic steel sheet 124a. Meanwhile, when the total thickness T of the one or more second electromagnetic steel sheets 124b that are alternately stacked with the one or more first electromagnetic steel sheets 124a is set to be twice or less than twice the size s of the gap g, the outlined portion of the permanent magnet 122 shown in FIG. 10 can be eliminated. Thus, the permanent magnet 122 can entirely obtain the effect of reducing the demagnetizing field in the rotation axis direction of the rotor 120.

Further, when the thickness t of each second electromagnetic steel sheet 124b is greater than the size s of the gap g, even in a case where the one or more first electromagnetic steel sheets 124a and one of the second electromagnetic steel sheets 124b are alternately stacked, some portions may fail to obtain the effect of reducing the demagnetizing field in each permanent magnet 122 for the aforementioned reasons. Meanwhile, when the thickness t of each second electromagnetic steel sheet 124b is equal to or smaller than the size s of the gap g, in a case where the one or more first electromagnetic steel sheets 124a and one of the second electromagnetic steel sheets 124b are alternately stacked, the permanent magnet 122 can entirely obtain the effect of reducing the demagnetizing field in the rotation axis direction of the rotor 120.

The embodiment of the rotor according to the present disclosure has been described in detail with reference to the drawings. However, the specific configuration is not limited to the embodiment, and the present disclosure encompasses any design changes and the like that are made within the scope of the gist of the present disclosure.

### DESCRIPTION OF SYMBOLS

120 Rotor
121 Slot
121a First slot hole
121b Second slot hole
122 Permanent magnet
122a Pole face
123 Cut-out portion
124 Rotor core
124a First electromagnetic steel sheet
124b Second electromagnetic steel sheet
g Gap
s Size of gap
t Thickness of second electromagnetic steel sheet
T Total thickness of one or more second electromagnetic steel sheets

What is claimed is:

1. A rotor comprising:
a rotor core;
a plurality of slots provided in the rotor core;
a plurality of permanent magnets, one or more of the plurality of permanent magnets being housed in each of the plurality of slots; and
a gap formed between at least one of pole faces of each of the plurality of permanent magnets and the rotor core,
wherein
the rotor core includes one or more first electromagnetic steel sheets and one or more second electromagnetic steel sheets alternately stacked,
each of the one or more first electromagnetic steel sheets has a plurality of first slot holes to form the plurality of slots, and
each of the one or more second electromagnetic steel sheets has a plurality of second slot holes to form the plurality of slots and a cut-out portion provided in a part of a peripheral wall of each of the plurality of second slot holes and forming the gap, the peripheral wall facing the pole faces of each of the permanent magnets.

2. The rotor according to claim 1, wherein the rotor core is configured with a stack of the plurality of first electromagnetic steel sheets and the plurality of second electromagnetic steel sheets, formed by alternately stacking the first electromagnetic steel sheets and the second electromagnetic steel sheets one by one.

3. The rotor according to claim 1, wherein when a thickness of each of the second electromagnetic steel sheets is defined as t, a total thickness of the one or more second electromagnetic steel sheets that are alternately stacked with the one or more first electromagnetic steel sheets is defined as T, and a size of the gap in a direction along a magnetic flux of each of the permanent magnets is defined as s, a relation of T≤2s and t≤s is satisfied.
